(19) United States
(12) Patent Application Publication
(10) Pub. No.: US 2007/0185876 A1
(43) Pub. Date: Aug. 9, 2007

(54) Data handling system

(76) Inventors: Venura C. Mendis, Ipswich (GB); Alex S.J. Palmer, Felixstowe (GB); Martin Russ, Ipswich (GB)

Correspondence Address: NIXON & VANDERHYE, PC, 901 NORTH GLEBE ROAD, 11TH FLOOR, ARLINGTON, VA, 22203, US

(21) Appl. No.: 10/589,613

(22) PCT Filed: Feb. 7, 2005
(86) PCT No.: PCT/GB05/00421

§ 371 Date: Aug. 16, 2006

(51) Int. Cl. G06F 17/30

(52) U.S. Cl. 707/10

(57) ABSTRACT

Media objects such as film clips that have been stored for subsequent retrieval are represented in a display. In order to apply metadata tags to the objects, a user selects an individual media object from the display, and allocates a designated tag or set of such tags to the selected media object by placing a representation of the selected media object in a region of the display representing the designated tag or set of tags, whereby data relating to the selected media object is stored associating it with the tags so identified.

This invention relates to a data handling system, and in particular a device for organising and storing data for subsequent retrieval.

The advent of low cost digital cameras, cheap storage space and the vast quantity of media available has transformed the personal computer into a multi-purpose home entertainment centre. The versatile communications medium known as the “Internet” allows recorded digital media files representing, for example, text, sound, pictures, moving images, numerical data, or software to be transmitted worldwide very easily.

Note that although the plural ‘media’ is used throughout this specification, the term ‘media file’ is to be understood to include files which are intended to be conveyed to a user by only one medium—e.g. text or speech—as well as ‘multimedia’ files which convey information using a plurality of such media.

The number of media files accessible via the Internet is very large, so it is desirable to label media files with some description of what they contain in order to allow efficient searching or cataloguing of media. Many users therefore add metadata to the individual objects in the media. Metadata are data that relate to the content or context of the object and allow the data to be sorted—for example it is common for digital data of many kinds to have their date of creation, or their amendment history, recorded in a form that can be retrieved. Thus, for example, HTML (HyperText Mark-up Language) files relating to an Internet web page may contain ‘metadata’ tags that include keywords indicating what subjects are covered in the web-page presented to the user. Alternatively, the keywords may be attached to a separate metadata object, which contains a reference to an address allowing access to the item of data itself. The metadata object may be stored locally, or it may be accessible over a long-distance communications medium, such as the Internet. Such addresses will be referred to herein as “media objects”, to distinguish them from the actual media files to be found at the addresses indicated by the media objects. The expression ‘media object’ includes media data files, streams, or a set of pointers into a file or database.

The structure of an individual media object consists of a number of metadata elements, which represent the various categories under which the object, (or more properly the information contained in the media file to which the object relates) may be classified. For example a series of video clips may have metadata elements relating to “actors”, “locations” “date of creation”, and timing information such as “plot development” or “playback order”, etc. For each element, any given media object may be allocated one or more metadata values, or classification terms, from a vocabulary of such terms. The vocabulary will, of course, vary from one element to another.

The metadata elements and their vocabularies are selected by the user according to what terms he would find useful for the particular task in hand: for example the values in the vocabulary for the metadata element relating to “actors” may be “Tom”, “Dick”, and “Harriet”, those for “location” might include “interior of Tom's house”, “Vienna street scene”, and “beach”, whilst those for “plot development” might include “Prologue”, “Exposition”, “Development”, “Climax”, “Denouement”, and “Epilogue”. Note that some metadata elements may take multiple values, for example two or more actors may appear in the same video clip. Others, such as location, may be mutually exclusive.

A user typically stores video and audio files and digital pictures in a hierarchical directory structure, classifying the media for subsequent retrieval. This is far from ideal as it is often impossible to decide on the amount of detail appropriate to organise a media library. In particular it often requires more technical skill than the user may have, in particular in a home context. In a business context the skills may be available, but the database may need to be accessed by several different people with different needs, not all of whom would have the necessary skills to generate suitable classification terms. The meticulous compilation of metadata is often a tedious process of trial and error, and requires the expenditure of substantial human resources. Moreover, a person performing the classification is unlikely to add metadata beyond what is sufficient to achieve his own current requirements. Consequently, the results may be of little use to subsequent users if the database is reused. In particular, it is difficult to ascertain whether each media object has been allocated all the metadata that might be appropriate to it, nor how useful an individual metadata tag may be in identifying useful material. Some metadata may apply to a large number of items, in which case additional metadata, detailing variations between the items identified thereby, may prove useful. Conversely, a tag allocated to very few items, or none at all, may be indicative of an area in which more media items should be obtained, or that for some reason the metadata have not been applied to items to which it would have been appropriate. Such considerations are difficult to address with existing systems. Data Clustering and Data mining algorithms such as the Minimal Spanning tree algorithm and K- means algorithm have conventionally been used to analyse databases and to attempt to fill out missing data. These algorithms are slow and usually run off line.

International patent application WO 02/057959 (Adobe) describes an apparatus to visually query a database and provide marking-up codes for its content. However, it does not let the user visualize how many marking-up codes are already present in the individual items making up the database. The interface described therein is not capable of handling complicated metadata schemes, as it would require too many ‘tags’, and this would lead to an extremely complicated interface that would not easily indicate which objects still have to be marked up. As in most applications that require metadata input, the main interface to adding metadata is text-based. Menus with pre-defined vocabularies can be called up to provide marking-up codes to objects or content.

The present invention seeks to simplify the metadata marking-up process. According to the present invention, there is provided a data handling device for organising and storing media objects for subsequent retrieval, the media objects having associated metadata tags, comprising a display for displaying representations of the media objects, data storage means for allocating metadata tags to the media objects, an input device comprising means to allow a representation of a selected media object to be moved into a region of the display representing a selected set of metadata tags, and means for causing the selected set of tags to be applied to the media object.

According to another aspect, the invention provides a method of organising and storing media objects for subsequent retrieval, the media objects being represented in a display, and in which metadata tags are applied to the media objects by selecting an individual media object from the display, and causing a set of metadata tags to be applied to the selected media object by placing a representation of the selected media object in a region of the display selected to represent the set of tags to be applied.

Note that some of the regions may represent sets have only one member, or none at all (the empty set). Other regions may represent intersection sets (objects having two or more specified metadata tags) or union sets (objects having any of a specified group of such metadata tags)

The invention provides an interface that can be used to visually add metadata to a database or collection of media objects. By placing representations of the elements in display areas representing the individual categories, a number of advantages are achieved. In particular, the number of items to which each item of metadata has been applied can be readily recognized, as all such items are collected in one region of the display. In addition, the size of the display area can be made proportional to the number of items it contains. This makes clusters of data easy for a user to identify and sort. A visual interface allows the differentiation or segmentation of existing groups, and the filling of missing metadata elements. It allows the user to sort the items into categories, which is a more natural process than applying the classification terms that relate to such categories to individual items.

The metadata marking-up process is preferably carried out by moving icons or other representations of media objects between regions of the display area representing sets of metadata tags having pre-defined values, selected from a vocabulary of suitable values. The user may have the facility to generate additional metadata tags having new values, such that the media objects may be further categorized.

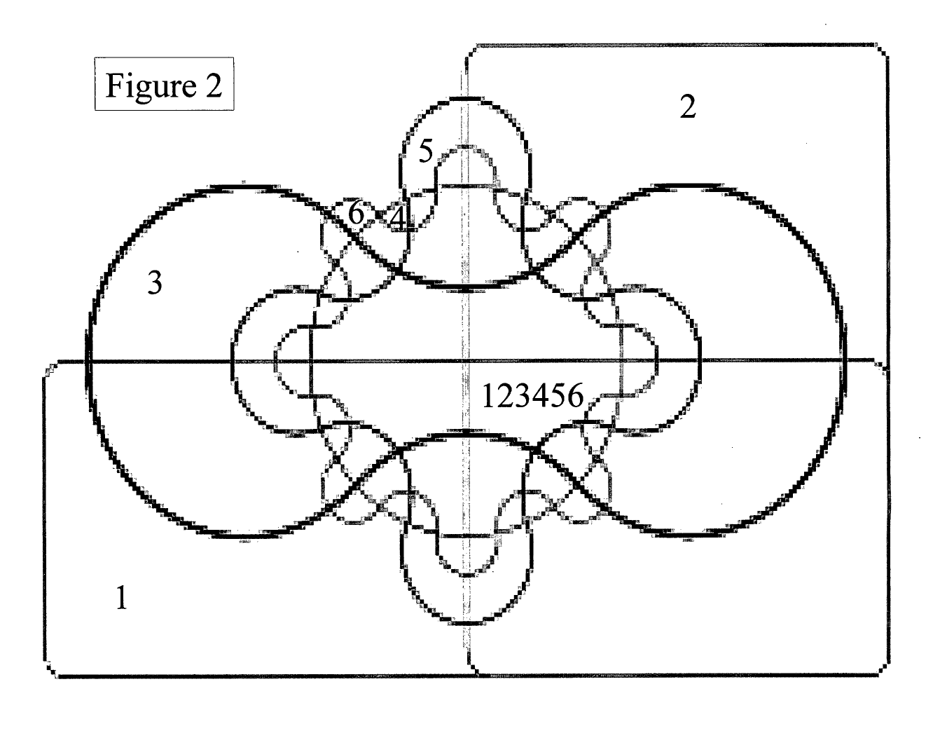

A representation of the metadata can be built up in terms of sets similar to Vein diagrams. However, Vein diagrams representing more than a very few different sets become very complex. FIG. 2 shows a Vein diagram for six sets. The regions 1, 2, 3, 4, 5, 6 each contain only one of the six sets, whilst the region 123456 is the union of all six sets. It can be seen that, even for only six sets, the diagram is extremely complex and difficult to follow—there are 2⁶=64 separate areas, representing the different possible combinations of the six sets. The invention uses a much simpler representation, but offers various functions allowing ready manipulation of the data represented. This representation offers visual hints to the user as to how far the marking-up has progressed, and which metadata elements are missing.

In a preferred embodiment, the user may select a plurality of categories, giving ready visualization of the metadata. He may take a multi-dimensional view of the search space, requesting several media objects to each of which at least one of a predetermined plurality of metadata tags has been applied. (Effectively, this is the “union” of the sets of objects having those values). Alternatively, he may take an “intersection” view, searching only for objects which have each had each of a predetermined plurality of metadata tags have been applied to them. Where a large number of such intersections are possible to be defined, the user may be allowed to control the maximum number of metadata tag sets to be displayed. The size of the display area allocated to each metadata tag may be made proportional to the number of media objects portrayed therein.

In a preferred embodiment representations of the media objects are capable of being moved between regions of the display area representing different metadata tags. To change the values associated with a media object, its representation icon may be removed from one display area when added to another. If the values are not mutually exclusive, it may instead remain in the first display area, with a copy placed in the additional area.

Means may be provided for indicating the number of metadata tags associated with one or more media objects, and in particular to identify media objects to which no categories have been applied.

Means may be provided for selecting a subset of the media objects for allocating a predetermined set of metadata tags.

The invention also extends to a computer program or suite of computer programs for use with one or more computers to provide apparatus, or to perform the method, in accordance with the invention as set out above.

A useful feature of the invention is that it guides the user to complete the minimum necessary marking-up to accomplish his task, and to provide a more even distribution of media objects. It does this by providing visual cues to help complete missing marking-up information and also provide a visual representation of the existing level of marking-up or completeness of a database. In particular, it may provide an indication of media objects for which no marking-up information has yet been applied for a particular element. In the described embodiment this takes the form of a display area in which “unclassified” objects are to be found.

The invention allows the visualization of the metadata allocated to a given media object in the context of the complete database of media objects. It also helps to generate and modify existing vocabularies. It lets the user create, modify or delete vocabularies during the markup process—for example by adding a new vocabulary value to a cluster, separating a cluster by adding several new vocabulary values, or changing the name of a vocabulary value after observing the objects in that cluster.

Some classification tasks could be accomplished automatically by running clustering algorithms on the database, but these processes consume time and resources. Providing the user with an effective interface lets him carry out these tasks much more quickly. The invention provides a more natural interface than the text-based prior art systems. It allows the user to sort the objects into categories (values) and creates and adjusts the metadata for each object based on how the user does this.

In a large database, there are likely to be too many individual elements in the metadata structure, or values in their vocabularies, to allow all of them to be displayed simultaneously. In the preferred arrangement an hierarchical structure is used to allow the user to select objects having specified elements and values, thus making the interface less cluttered by letting the user view only those metadata objects having elements in which he is currently interested. He may then sort them using different search terms (elements).

As will be understood by those skilled in the art, the invention may be implemented in software, any or all of which may be contained on various transmission and/or storage mediums such as a floppy disc, CD-ROM, or magnetic tape so that the program can be loaded onto one or more general purpose computers or could be downloaded over a computer network using a suitable transmission medium. The computer program product used to implement the invention may be embodied on any suitable carrier readable by a suitable computer input device, such as CD-ROM, optically readable marks, magnetic media, punched card or tape, or on an electromagnetic or optical signal.

An embodiment of the invention will now be further described, by way of example only, with reference to the drawings, in which:

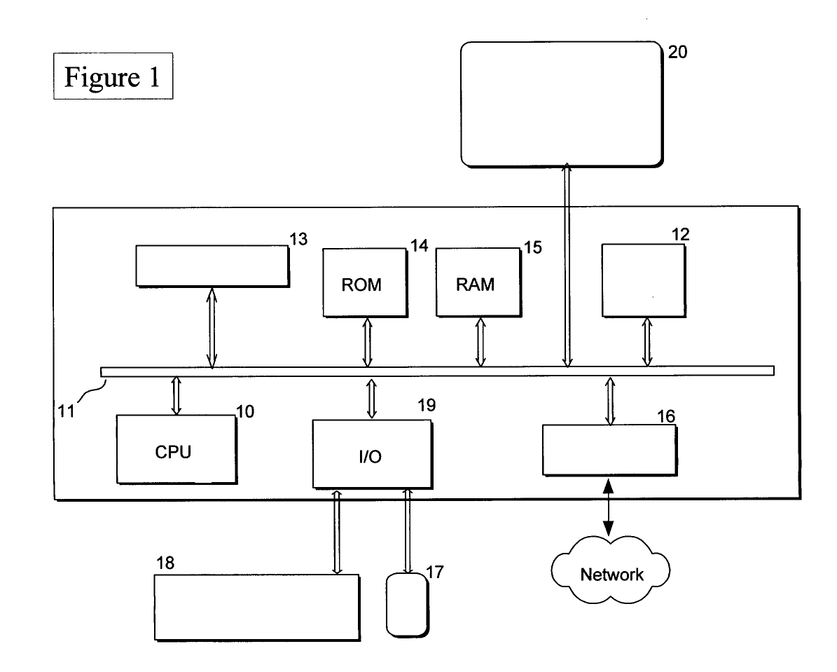

FIG. 1 is a schematic diagram of a typical architecture for a computer on which software implementing the invention can be run;

FIG. 2 is a representation of a six-set Vein Diagram;

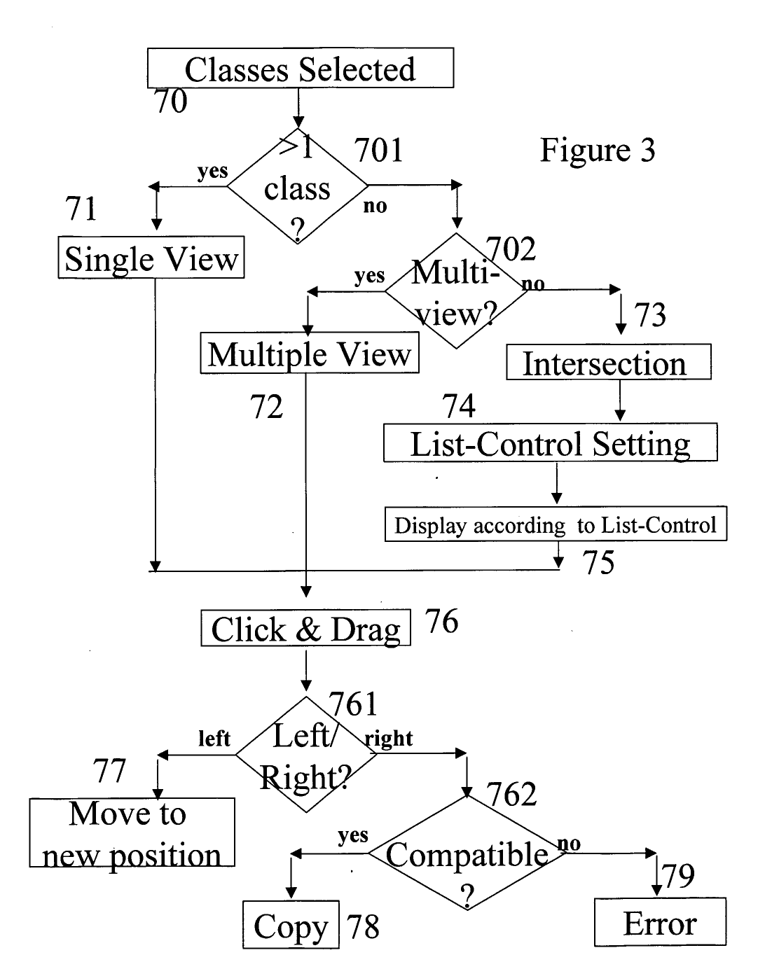

FIG. 3 is a flow diagram showing a simplified view of the processes performed by the invention;

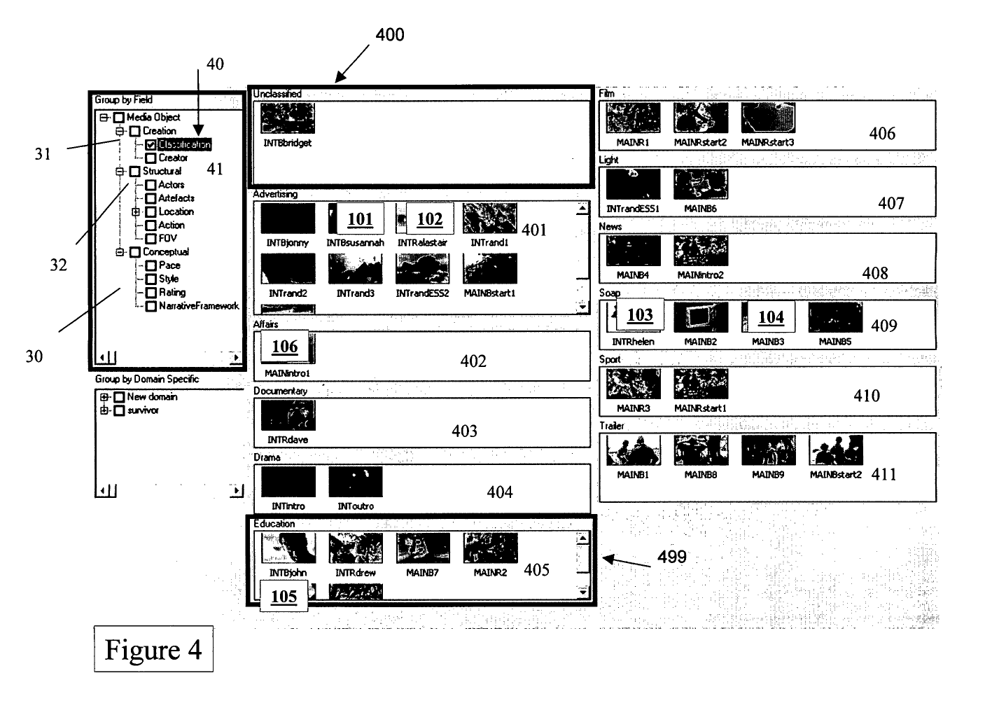

FIG. 4 is a representation of a screen shot generated during a single dimensional viewing process;

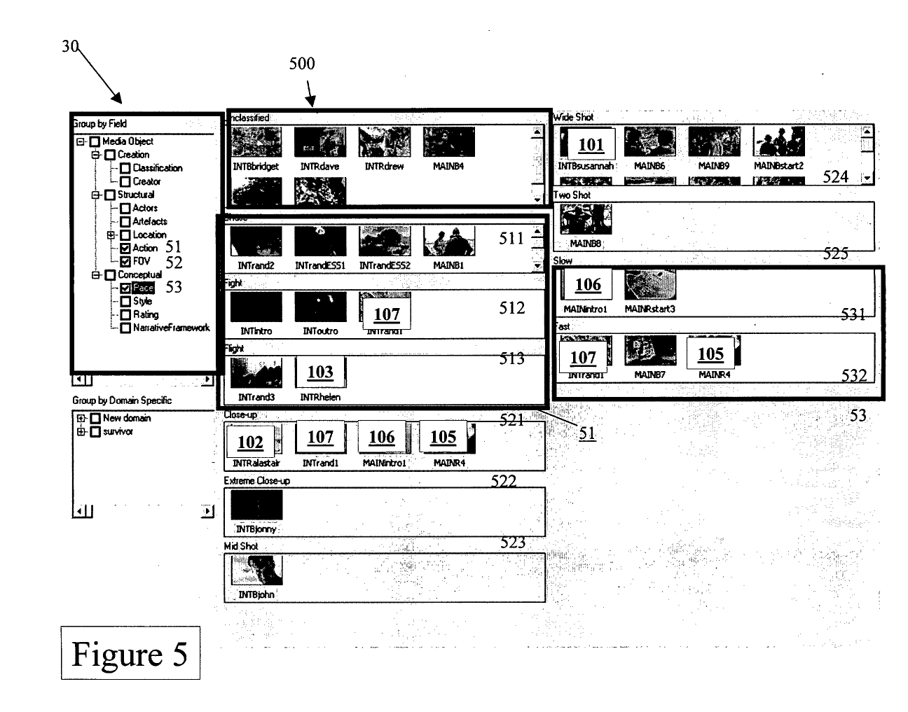

FIG. 5 is a representation of a screen shot generated during a more complex multi-dimensional viewing process;

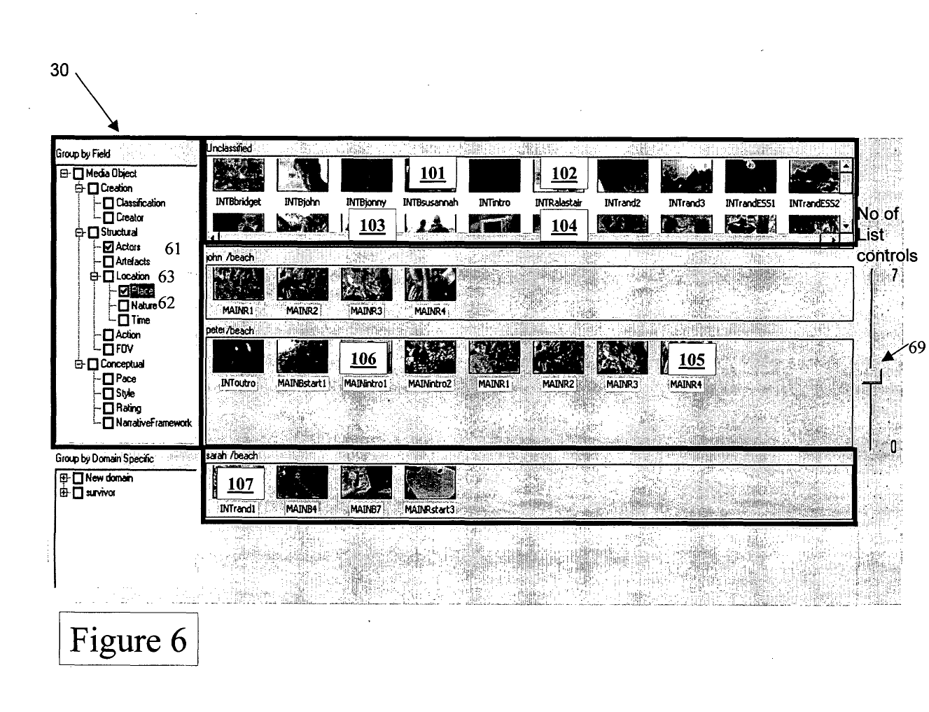

FIG. 6 is a representation of a screen shot generated during a viewing process including intersections of metadata sets.

FIG. 1 shows the general arrangement of a computer suitable for running software implementing the invention. The computer comprises a central processing unit (CPU) 10 for executing computer programs, and managing and controlling the operation of the computer. The CPU 10 is connected to a number of devices via a bus 11. These devices include a first storage device 12, for example a hard disk drive for storing system and application software, a second storage device 13 such as a floppy disk drive or CD/DAD drive for reading data from and/or writing data to a removable storage medium and memory devices including ROM 14 and RAM 15. The computer further includes a network card 16 for interfacing to a network. The computer can also include user input/output devices such as a mouse 17 and keyboard 18 connected to the bus 11 via an input/output port 19, as well as a display 20. The person skilled in the art will understand that the architecture described herein is not limiting, but is merely an example of a typical computer architecture. It will be further understood that the described computer has all the necessary operating system and application software to enable it to fulfill its purpose.

The embodiment provides three main facilities for handling a media object. In this example it is a software object that contains a reference to a video/audio clip and contains metadata about it.

The first of these facilities is a simple visual interface, which lets the user add metadata by moving icons or “thumbnail” images representing media objects between two areas using a control device—a process known as “drag and drop”. This is shown in FIG. 4. FIG. 4 also illustrates the selection of sorting criteria from a hierarchical menu list 30. This allows a user to quickly switch between different dimensions or layers, or between different metadata elements. In this example the metadata element “classification” (represented by the element 40 in the hierarchical display 30) has been selected, and a number of values from the vocabulary for that element are displayed—“Advertising” 401, “affairs” 402, “documentary” 403, etc. These define sets that are made up of media objects having these respective values for the “classification” metadata element.

Media objects to which no value has yet been applied for this specified metadata element are displayed in a separate field 400. This second facility allows unmarked media objects to be identified so that the user can perform the marking-up operation.

The third facility, illustrated in FIGS. 5 and 6, allows a set of media objects that have one or more common elements to be identified, and allows the user to separate or differentiate the media objects by adding new or different metadata, or to find some other criteria that achieve a further distinction between the media objects.

The query process, which is common to all the variants, will now be described with reference to FIG. 4.

The process can be started in either of two modes—either directly acting on the entire database, or from the template view. The latter approach allows mark-up of a single cluster in the database, and segmentation of only the objects in that cluster. It also provides a less cluttered view for the user. In doing this it prevents unnecessary metadata from being added. Viewing this collection of objects within the visual marking-up tools lets the user easily visualize any metadata that might differentiate them, and if there is insufficient differentiation it allows the user to modify existing metadata to represent the object more accurately.

A metadata element, or combination of such elements, is selected by selecting one or more categories 32 in the hierarchical structure 30 (step 70—FIG. 3). A control element of the user interface, containing a textual or graphical representation of the selections available, may be populated by appending an additional query to the template view described in the previous paragraph, identifying the media objects to which marking-up is to be applied. By populating the control elements in this manner it is possible to visualize the metadata marking-up in the entire database, or a defined subset of it, using any of the views described below. The media objects may be represented as either miniature images, as illustrated in the Figures (“Thumbnail” view) or as a plain text filename (Text-only view).

To add annotation to a particular element in the media object data model, it is first necessary to select the desired element in the hierarchical menu structure. As only a single class has been selected in this example, the extra steps 72-75 are omitted (these will be discussed later) and a set of List controls or boxes 400-411 is generated for each value in the vocabulary of available terms stored for each respective element (step 71). Existing metadata can be visualized by the manner in which media objects are arranged in the different boxes. Media objects that are in the ‘unclassified’ box 400 do not contain any metadata values for the particular element selected in the hierarchical menu structure. If the metadata values are not mutually exclusive, media objects may appear in more than one box.

The process requires a number of additional steps 72-75 if more than one metadata tag has been selected, as will be discussed later with reference to FIGS. 5 and 6. However, if only a single metadata tag has been selected (step 701), a single-metadata tag view is generated (step 71). In the example shown in FIG. 4 the “Classification” element 41 has been selected under the “Creation” heading 40, and a number of metadata classes—“advertising” 401, “affairs” 402, “documentary” 403, “drama” 404, “Education” 405, “Film” 406, etc. Are displayed as windows, each containing those media objects to which that metadata tag has been applied. Each individual media object 101, 102, etc. Is represented in the appropriate window by “thumbnail” images or other suitable means.

The size of the display area representing each metadata tag is determined according to the number of media objects to be displayed. Large groups, such as those shown at 401, 405, may be partially represented, with means 499 for scrolling through them. Thus a view of the various media objects 101, 102, 103, 104, 105, 106, 107 etc., is generated, sorted according to the various “classification” categories (metadata values) 401, 402, 403 etc. Including an “unclassified” value 400. The view of existing metadata is similar to a Vein diagram with non-overlapping sets. (If the sets were allowed to overlap—that is to say, one media object can have two or more metadata values applied to it—identical copies of the same object may appear in several of the boxes). All items are originally located in the “unclassified” set 400. The process of adding metadata to media objects relies on ‘dragging and dropping’ objects in and out of classification boxes (step 76), each box being representative of a specific metadata value. The visual representation of the contents of each set makes it straightforward to ensure that similar media objects are placed in the same set (allocated the same tags). A user can also identify which categories are most heavily populated, and therefore worthy of subdivision. This would allow the distribution of the metadata in a database to be “flattened” i.e. All the media objects should have similar amount of metadata associated with them.

The list controls are populated by inserting the metadata associated with the media object. To do this the user ‘sorts’ the media objects using a “drag and drop” function (76), for example using the left button of a computer “mouse”. For the particular media object that is moved by that operation, the metadata value originally stored for it, which is represented by the box in which it was originally located, is replaced by the value represented by the box to which it is moved (step 77). Moving from the “unclassified” area adds a value where none was previously recorded. If it is desired to delete a value, the object is moved from the box representing that value to the “unclassified” box.

In a single view, if the metadata element is extensible—that is to say, it can have multiple values—such as “actors”, moving to “unclassified” only removes one actor (the one it was moved from)—the others are unchanged. The icon that was moved to “unclassified” would be deleted if other values for the element still exist for that object. Deletion operates in a different way when multi-dimensional views are in use, as will be discussed later.

If a value is to be added, rather than replace an existing one, a “right click” drag-and-drop operation would generate a copy (step 78)—in other words for that particular media object the metadata value represented by the box that it is “dropped” in is copied to that particular element but not deleted from the original element.

In this case a check is made (step 761) to ensure that the “copy” operation is valid: in other words to check that the origin and destination metadata elements are not mutually exclusive. If the multi dimensional view is being used, as will be discussed with reference to FIG. 5, a check is also made as to whether the proposed move is between boxes that represent different metadata elements, and not just different values in the vocabulary of one metadata element. An error message (79) is generated if such an attempt is made. Attempting to copy to or from the “unclassified” area would also generate an error message.

The processor 10 automatically populates the list boxes 401, 402, 403, etc. By querying the database 15 for media objects that contain the metadata values that are represented by the boxes to be displayed. The unclassified box is populated by running a NOT query for all the metadata values.

In the single-dimensional view shown in FIG. 4, the user selects a single metadata element 41 from the hierarchical menu structure 30 (step 70). In the illustrated example this is the “classification” element 41. The media objects are now sorted according to the vocabulary values of their respective metadata elements (step 71)—for example, “advertising” 401, “affairs” 402, “documentary” 403, “Drama” 404, “Education” 405, “Film” 406 etc. An empty box may appear—this denotes a metadata value defined in the database vocabulary but not used by any of the objects. An unclassified box 400 contains media objects (e.g. 100) that do not contain any values for the selected metadata element.

As shown in FIGS. 5 and 6, more than one metadata element may be selected by identifying more than one check box (step 701). The user may select whether to display a multi dimensional view (depicted in FIG. 5, step 72) or an “Intersection” view (steps 73-75, depicted in FIG. 6). In the multidimensional view shown in FIG. 5 the metadata elements “Action” 51, “FOB” (field of view) 52 and “Pace” 53 have been selected. This produces three sets of list controls: one for each of the metadata elements. These three sets may be denoted in different colors to indicate boxes or values that belong to the same vocabulary element in the multi dimension view, to improve clarity for the user. This view provides the user a simple way of visualizing the metadata values in different metadata elements of the media objects.

As in the single dimensional view (FIG. 4), the list controls 511-513, 521-525, 531-532, in each set represent metadata values for a given metadata element 51, 52, 53. An individual metadata element may appear in more than one set, if it has a value for each element represented. The ‘Unclassified’ box 500 contains the media objects that do not contain any of the metadata values that are represented by all the list controls.

In this view, copying (Right click drag and drop) between different list control groups 51, 52 (Different colors) is always allowed (steps 76, 761, 78). This is because this copying is merely adding a new value to a different metadata element: if there is already a value in that given metadata element it will be replaced. Copying between list controls 511, 512 in the same metadata element set 51 (Same color) is only possible if that particular metadata element is of a type that allows multiple values. In the multi selection view, moving an object to the “unclassified” area would only delete the value of the metadata element from which it was moved. For example, an object 107 appears in both the “fight” box 512 (Action element 51) and the “fast” box 532 (Pace element 53). If it is moved from “fast” 532 to “unclassified” 500, only the value in the “pace” metadata element 53 would be deleted—the “Action” element 512 would remain unchanged An “Intersection” View (step 73), as shown in FIG. 6, may instead be selected by the user (step 702). This view is similar to the multi-dimensional view described with reference to FIG. 5. Again the user selects multiple values from the hierarchical menu structure using check boxes, in the example shown in FIG. 6. Here the “Actors” metadata element 61 and the “Place” metadata element 62 have been selected. (The latter is a subdivision of the “location” element 63 in the hierarchical menu structure). The user has selected three list controls as the maximum to display. Hence three combinations of Actor and Location values (Actor=John, Peter, Sarah: Location=Beach) are generated (step75). Alternatively if the user sets the number of list controls to a higher value, other list controls would be generated (Individual list controls for each actor and location). In the “intersection” view, if an object is moved from an intersection box to “unclassified”, all the values represented in that intersection would be deleted. For example, by moving an object 106 from the “Peter/beach” box in FIG. 6, the value “Peter” would be removed from the “actor” element, and the value in the “location” element (“beach”) would also be deleted.

In this view, the number of possible list controls is the product of the number of terms n₁ n₂ n₃ . . . in each set (if mutually exclusive), or 2^{N} where N is the sum of the number of terms in each set that may be applied (if not mutually exclusive) n₁+n₂+n₃+ . . . . This may be a much larger number of categories than can conveniently be accommodated on a conventional display device, so the user is given the facility to limit the number of list controls represented (step 74), by using a slider 64 or some other selection means. The number of metadata elements the user can simultaneously choose is also restricted to three. This is to prevent excessive processing time and system running out of resources.

By identifying the boxes that contain the most objects, and which ones have the least or even none, the user can decide which vocabulary terms are most relevant to a database and get a much better idea of how much more marking-up he needs to do. Moreover, the multi-dimensional view (FIG. 5) and intersection view (FIG. 6) afford visual hints to the user to fill in missing metadata values. The user can graphically see which metadata element or values produce which cluster. So by using this in combination with a template the user can easily generate the movie clips he desires by adding markup just to the clips he is interested in. The user can see the markup of an object relative to all the others in the database, and so he is given an idea of how much more markup is needed to add it into a cluster or differentiate it when it is in a cluster.

The invention may be used to compile a media article such as a television programme using a wide variety of media, such as text, voice, other sound, graphical information, still pictures and moving images. In many applications it would be desirable to personalise the media experience for the user, to generate a “bespoke” media article.

Digital sets of stored media objects can be stored in a variety of formats, for example, a file may merely contain data on the position of components seen by a user when playing a computer game—the data in that file subsequently being processed by rendering software to generate an image for display to the user.

A particular use of such metadata is described in International Patent application PCT/GB2003/003976, filed on 15 Sep. 2003, which is directed to a method of automatically composing a media article comprising:

analysing digital metadata associated with a first set of stored media objects, which digital metadata includes:
related set identity data identifying a second set of stored media objects;
and relationship data which indicates the relationship between what is represented by the first set of stored media objects and what is represented by the second set of stored media objects;

and arranging said first and second sets of stored media objects in a media article in accordance with said analysis.

This uses detailed formal and temporal metadata of the kind already described, (e.g. identifying individual actors or locations appearing in a video item, and time and sequence related information). A set of filters and combiners are used to construct a narrative by arranging media objects in a desired sequence. The present invention may be used to apply metadata records for each media object available for use in such a compilation.

1. A data handling device for organising and storing media objects for subsequent retrieval, the media objects having associated metadata tags, comprising a display for displaying representations of the media objects, data storage means for allocating metadata tags to the media objects, an input device comprising means to allow a representation of a selected media object to be moved into a region of the display representing a selected set of metadata tags, and means for causing the selected set of tags to be applied to the media object.

2. A device according to claim 1, configured to allow a user to generate additional metadata tags having new values, such that the media objects may be further categorized.

3. A device according to claim 1, configured to provide a view of media objects to which one or more of a predetermined plurality of metadata tags have been applied.

4. A device according to claim 1, configured to provide a view of media objects to which each of a predetermined plurality of metadata tags have been applied.

5. A device according to claim 4, wherein means are provided to provide user control of the maximum number of metadata tag sets to be displayed.

6. A device according to claim 1, in which representations of the media objects are capable of being moved between regions of the display area representing sets of metadata tags having pre-defined values.

7. A device according to claim 6, comprising means for removing a representation of a selected media object from one display area and adding it to another, thereby applying the metadata tag set associated with the second area to the selected media object in place of the set of metadata tags associated with the first area.

8. A device according to claim 6 wherein a representation of a media object selected from a display area associated with a first metadata tag set applied to the media object may remain there whilst a copy of the selected media object is placed in a second area, thereby applying the metadata tag set associated with the second area to the media object in addition to the set associated with the first area.

9. A device according to claim 1, providing means for indicating the number of media objects associated with a given set of metadata tags.

10. A device according to claim 1, providing means for indicating the number of metadata tags associated with one or more media objects.

11. A device according to claim 10, providing means for identifying media objects to which no metadata tags have been applied by providing a display area representing an empty set.

12. A device according to claim 1, providing means for selecting a subset of the media objects for allocating a given set of metadata tags.

13. A device according to claim 1, providing means for making the size of the display area allocated to each set of metadata tags proportional to the number of media objects portrayed therein.

14. A computer program or suite of computer programs for use with one or more computers to provide any of the apparatus as set out in claim 1.

15. A method of organising and storing media objects for subsequent retrieval, the media objects being represented in a display, and in which metadata tags are applied to the media objects by selecting an individual media object from the display, and causing a set of metadata tags to be applied to the selected media object by placing a representation of the selected media object in a region of the display selected to represent the set of tags to be applied.

16. A method according to claim 15, in which a user may generate additional metadata tags having new values, such that the media objects may be further categorised.

17. A method according to claim 15, wherein a view is provided of media objects to which one or more of a predetermined plurality of metadata tags have been applied.

18. A method according to claim 15, wherein a view is provided of media objects to which each of a predetermined plurality of metadata tags have been applied.

19. A method according to claim 15, wherein provision is made to control the maximum number of categories to be displayed.

20. A method according to claim 15, in which representations of the media objects are moved between regions of the display area representing sets of metadata tags having pre-defined values.

21. A method according to claim 20, wherein a representation of a media object is selected from a first display area associated with a first metadata tag set, and a copy of the selected representation is placed in a second area whilst the original representation remains in the first area, thereby applying the metadata tag set associated with the second area to the media object, in addition to the set associated with the first area.

22. A method according to claim 20 wherein a representation of a selected media object may be removed from a first display area associated with one metadata tag set when added to a second display area, thereby applying the set of metadata tags associated with the second display area to the selected media item in place of the set of metadata tags associated with the firs display area.

23. A method according to claim 15, wherein the number of media objects associated with a given set of metadata tags is indicated.

24. A method according to claim 15, wherein the number of metadata tags associated with one or more media objects is indicated.

25. A method according to claim 24, wherein media objects to which no metadata tags have been applied are identified by providing a display area representing an empty set.

26. A method according to claim 15, wherein a subset of the media objects may be selected for allocation of a given set of metadata tags.

27. A method according to claim 15, wherein the size of the display area allocated to each set of metadata tags is proportional to the number of media objects portrayed therein.

28. A computer program or suite of computer programs for use with one or more computers to provide the method of claim 15.
